(19) United States
(12) Patent Application Publication
(10) Pub. No.: US 2007/0099005 A1
(43) Pub. Date: May 3, 2007

(54) Thick crack-free silica film by colloidal silica incorporation

(75) Inventors: Roger Y. Leung, San Jose, CA (US); Jan Nedbal, San Jose, CA (US); Jinghong Chen, Santa Clara, CA (US); Amanuel H. Gebrebrhan, San Carlos, CA (US); Beth C. Munoz, San Jose, CA (US)

Correspondence Address: Richard S. Roberts;Roberts & Roberts, L.L.P., Attorneys at Law, P.O. Box 484, Princeton, NJ, 08542-0484, US

(73) Assignee: Honeywell International Inc.

(21) Appl. No.: 11/262,588

(22) Filed: Oct. 31, 2005

(51) Int. Cl. B32B 9/04; C08G 77/08

(52) U.S. Cl. 428/447; 428/429; 428/450; 528/21; 528/23

(57) ABSTRACT

The invention relates to low temperature curable spin-on glass materials which are useful for electronic applications, such as optical devices, in particular for flat panel displays. A substantially crack-free silicon polymer film is produced by (a) preparing a composition comprising at least one silicon containing pre-polymer, colloidal silica, an optional catalyst, and optional water; (b) coating a substrate with the composition to form a film on the substrate, (c) crosslinking the composition by heating to produce a substantially crack-free silicon polymer film, having a thickness of from about 700 Å to about 20,000 Å, and a transparency to light in the range of about 400 nm to about 800 nm of about 90% or more.

### BACKGROUND OF THE INVENTION

1. Field of the Invention

The present invention relates to thick crack-free spin-on glass materials which are useful for electronic applications. More particularly, the invention pertains to thick crack-free spin-on glass materials which are useful for optical devices such as flat panel displays.

2. Description of the Related Art

In the electronic component and flat panel display manufacturing industry, there is a continuing need for thick silica films for a planarization/insulation layer in flat panel display applications. There is an economic need to replace CVD silicate by liquid coating procedure to reduce costs associated with large panel size. However, traditional sol-gel organic-free silicate films have a crack threshold of about 7000 Å. Organic components are not tolerated due to the requirement of oxygen plasma resistance. The present invention incorporates a colloidal silica into a sol-gel film, thus rendering a >10 KÅ crack-free silicate film.

This invention uses nm-size colloidal silica to increase the crack threshold of the silicate film which is produced by hydrolysis/condensation of silanes such as tetraethoxysilane (TEOS). The nm-size filler decreases the shrinkage of the film during curing from 11% to close to zero (essentially no shrinkage), thus reducing the stress and producing >1 μm crack-free films. Also, the film does not contain organic components and the colloidal silica is dispersed uniformly and stably in the coating solution. Convention coating procedure and equipment can be used to attain good gap fill, good planarization, and a film with adjustable densities.

The production of display devices such as electro-optic elements, thin film transistors, and display devices is known from U.S. Pat. No. 6,674,106, which is incorporated herein by reference. The fabrication of such components often requires the deposition of light transmissive dielectric materials used as planarization layers, gate dielectrics, passivation layers or interlayer dielectrics, onto features present on substrates in order to achieve proper isolation between devices. Each feature is separated by the insulating layer filled between them. These planarization layers and passivation layers need to fill spaces between narrow features without cracking. In the manufacture of optical devices such as flat panel displays, these gate dielectrics, planarization layers and passivation layers may need to have a transparency to light in the range of about 400 nm to about 800 nm of about 90% or more. In addition, unlike CVD, spin-on is a non-conformal coating process offering better planarization ability than CVD. Better planarization of TFT (thin film transistor) in flat panel display will improve aperture ratio, thus improving light utilization efficiency of displays.

Silicon-based dielectric films such as silicate, silazane, silisequioxane or siloxane generally exhibit good gap-fill properties. The silicon-based dielectric films are formed by applying a silicon-containing pre-polymer onto a substrate followed by crosslinking. Historically, silicon-based dielectric films exhibit stability in film thickness, crosslinking density and other enhanced film properties, such as, minimum moisture absorption, high field breakdown voltage, low current leakage and resistance to organic solvent/chemicals after high temperature cures. In optical applications, organic materials that are being used as a part of the device are often unstable at higher temperature. Thus, there exists a need in the art for dielectric spin-on materials that provide crack-free gap-fill of wide and narrow features at low process temperatures. It may also be useful for such materials to have adequate mechanical strength to withstand chemical mechanical polishing and have enhanced wet etch resistance. Films can be achieved at low temperatures by using a dielectric precursor composition comprising a substantially uniform admixture of a silicon containing pre-polymer and a colloidal silica with an optional condensation/cross-linking catalyst including alkali metal such as sodium, ammonium compounds, amines, phosphonium compounds and phosphine compounds. Through the use of a catalyst one can effectively lower the condensation temperature and/or drive the extent of crosslinking of silanol groups. A balance between the amount of organic content, density of the film and mechanical strength has to be maintained. Typically, silicon-based dielectric films, including silica dielectric films, are prepared from a composition comprising a suitable silicon containing pre-polymer, colloidal silica and an optional catalyst, such as an alkali metal or a metal-ion-free catalyst and one or more optional solvents and/or other components may also be included. The dielectric precursor composition is applied to a substrate suitable, e.g., for production of a semiconductor device, such as an integrated circuit (“IC”) or optics, by any art-known method to form a film. The composition is then crosslinked, such as by heating to produce a gelled film. The gelled film is then heated to produce a stable film.

In the photolithography process, oxygen plasma is commonly used for photoresist removal. In applications where the planarization layer is exposed to oxygen plasma, it is therefore desirable for the underlayer planarization materials not to be etched by the oxygen plasma. Since materials containing organic content do not resist to oxygen plasma, an organic-free silicate film will be preferred. Conventional silicate sol-gel film has a crack threshold thickness of about 7000 Å. For materials not exposed to oxygen plasma, organic-containing silicate can be used. The current invention teaches the use of colloidal silica in silicate and organosilicate sol-gel films, resulting in several nanometer crack-free films not attainable without the filler incorporation.

The films produced by the processes of the invention have a number of advantages over those previously known to the art, including improved crack resistance, that enables the produced film to be used in the optics. The property of a stable dielectric constant is advantageously achieved without the need for further surface modification steps to render the film surface hydrophobic, as was formerly required by a number of processes for forming silica dielectric films. Instead, silicon-based dielectric films as produced by the processes of the invention are sufficiently hydrophobic as initially formed.

### SUMMARY OF THE INVENTION

The invention provides a dielectric precursor composition comprising a substantially uniform admixture of a silicon containing pre-polymer and a colloidal silica.

The invention also provides a dielectric composition comprising a substantially uniform admixture of a silicon-based dielectric polymer and a colloidal silica.

The invention also provides a method of producing a dielectric film comprising:

(a) preparing a dielectric precursor composition comprising a substantially uniform admixture of a silicon containing pre-polymer and a colloidal silica;

(b) coating a substrate with the dielectric precursor composition to form a film on the substrate;

(c) crosslinking the dielectric precursor composition to produce a dielectric film comprising a substantially uniform admixture of a silicon containing dielectric polymer and a colloidal silica, such film having a transparency to light in the range of about 400 nm to about 800 nm of about 90% or more.

### BRIEF DESCRIPTION OF THE DRAWINGS

FIG. 1 is a schematic partial sectional view showing a partial section of an example of a conventional active matrix thin film transistor device.

FIG. 2 shows another type of conventional thin film transistor display device.

### DETAILED DESCRIPTION OF THE INVENTION

Silicon-based dielectric films are prepared from a composition comprising a suitable silicon containing pre-polymer, blended with a colloidal silica, optional catalyst, which may be a metal containing catalyst, a metal-ion-free catalyst or a nucleophile, and optionally water. One or more optional solvents and/or other components may also be included. The dielectric precursor composition is applied to a suitable substrate, e.g., for production of a device such as a semiconductor device, an integrated circuit (“IC”), a display device, a thin film transistor or the like, by any art-known method to form a film. The composition is then crosslinked to produce a silica dielectric film.

The films produced by the processes of the invention have a number of advantages over those previously known to the art, including curability by heating at a temperature of about 600° C. or less, and a transparency to light in the range of about 400 nm to about 800 nm of about 90% or more. Preferably the film is substantially crack-free, gap-fill, and withstands the further processing steps required to prepare an electronic device. The film may be a fully dense structure or may contain uniformly distributed nano-size pores. Density of the film may vary, depending on the degree of porosity.

Silicon-based dielectric films are prepared from suitable compositions applied to substrates in the fabrication of electronic devices. Art-known methods for applying the dielectric precursor composition, include, but are not limited to, spin-coating, dip coating, brushing, rolling, and/or spraying. Prior to application of the base materials to form the dielectric film, the substrate surface is optionally prepared for coating by standard, art-known cleaning methods. The coating is then applied and processed to achieve the desired type and consistency of dielectric coating, wherein the processing steps are selected to be appropriate for the selected precursor and the desired final product. Further details of the inventive methods and compositions are provided below.

A “substrate” as used herein includes any suitable composition formed before a silica film of the invention is applied to and/or formed on that composition. For example, a substrate may be a glass for producing a flat panel display, or a silicon wafer suitable for producing an integrated circuit. The silicon-based dielectric material from which the silica film is formed is applied onto the substrate by conventional methods. Suitable substrates for the present invention non-exclusively include films, glass, ceramic, plastic, metals, composite materials, silicon and compositions containing silicon such as crystalline silicon, polysilicon, amorphous silicon, epitaxial silicon, silicon dioxide (“SiO₂”), silicon nitride, silicon oxide, silicon oxycarbide, silicon carbide, silicon oxynitride, organosiloxanes, organosilicon glass, fluorinated silicon glass, and semiconductor materials such as gallium arsenide (“GaAs”), and combinations thereof. In other embodiments, the substrate comprise a material or materials common in the packaging and circuit board industries such as silicon, glass, and polymers. A circuit board made of the present composition may have surface patterns for various electrical conductor circuits n its surface. The circuit board may include various reinforcements, such as woven non-conducting fibers or glass cloth. Such circuit boards may be single sided, as well as double sided. For flat panel displays, the substrate preferably has a transparency to light in the range of about 400 nm to about 800 nm of about 90% or more, preferably about 95% or more, and usually about 99% or more. In one embodiment the substrate has a transparency to light in the range of about 400 nm to about 800 nm of about 100%.

On the surface of the substrate is an optional pattern of electrodes or raised lines, such as oxide, nitride, metal or oxynitride lines which are formed by well known lithographic techniques. Suitable materials for the lines include silicon oxide, silicon nitride, indium tin oxide (ITO), molybdenum electrode, chromium electrode, aluminum electrode, nickel and silicon oxynitride. In flat thin film transistor and panel display applications, red, green and blue sub-pixels are built into the substrate. Other optional features of the surface of a suitable substrate include an oxide layer, such as an oxide layer formed by heating a silicon wafer in air, or more preferably, an SiO₂ oxide layer formed by chemical vapor deposition of such art-recognized materials as, e.g., plasma enhanced tetraethoxysilane oxide (“PETEOS”), plasma enhanced silane oxide (“PE silane”) and combinations thereof, as well as one or more previously formed silica dielectric films.

The silicon-based dielectric films of the invention can be applied so as to cover and/or lie between optional electronic surface features, e.g., circuit elements and/or conduction pathways that may have been previously formed features of the substrate. Such optional substrate features can also be applied above the silica film of the invention in at least one additional layer, so that the low dielectric film serves to insulate one or more, or a plurality of electrically and/or electronically functional layers of the resulting integrated circuit. Thus, a substrate according to the invention optionally includes a silicon material that is formed over or adjacent to a silicon-based dielectric film of the invention, during the manufacture of a multilayer and/or multicomponent integrated circuit. In a further option, a substrate bearing a silicon-based dielectric film or films according to the invention can be further covered with any art known non-porous insulation layer, e.g., a glass cap layer.

It should be understood that within the context of this invention, the term gelling refers to condensing, or polymerization, of the combined silica-based precursor composition on the substrate after deposition. The crosslinkable composition employed for forming silica dielectric films according to the invention includes one or more silicon-containing prepolymers that are readily condensed. It should have at least two reactive groups that can be hydrolyzed. Such reactive groups include, alkoxy (RO), acetoxy (AcO), etc. Without being bound by any theory or hypothesis as to how the methods and compositions of the invention are achieved, it is believed that water hydrolyzes the reactive groups on the silicon monomers to form Si—OH groups (silanols). The latter will undergo condensation reactions with other silanols or with other reactive groups, as illustrated by the following formulas:
Si—OH+HO—Si->Si—O—Si+H₂O
Si—OH+RO—Si->Si—O—Si+ROH
Si—OH+AcO—Si->Si—O—Si+AcOH
Si—OAc+AcO—Si->Si—O—Si+Ac₂O
R=alkyl or aryl
Ac=acyl(CH₃CO)

These condensation reactions lead to formation of silicon containing polymers. In one embodiment of the invention, the prepolymer includes a compound, or any combination of compounds, denoted by Formula I:
Rx-Si-Ly (Formula I)
wherein x is an integer ranging from 0 to about 2 and y is 4-x, an integer ranging from about 2 to about 4),
R is independently alkyl, aryl, hydrogen, alkylene, arylene, and/or combinations of these,
L is independently selected and is an electronegative group, e.g., alkoxy, carboxyl, amino, amido, halide, isocyanato and/or combinations of these.

Particularly useful prepolymers are those provided by Formula I when x ranges from about 0 to about 2, y ranges from about 2 to about 4, R is alkyl or aryl or H, and L is an electronegative group, and wherein the rate of hydrolysis of the Si-L bond is greater than the rate of hydrolysis of the Si—OCH₂CH₃ bond. Thus, for the following reactions designated as (a) and (b):
(a) Si—L+H₂O->Si—OH+HL
(b) Si—OCH₂CH₃+H₂->Si—OH+HOCH₂CH₃

The rate of (a) is greater than rate of (b).

Examples of suitable compounds according to Formula I include, but are not limited to:

| | |
|---|---|
| Si(OCH₂CF₃)₄ | tetrakis(2,2,2-trifluoroethoxy)silane, |
| Si(OCOCF₃)₄ | tetrakis(trifluoroacetoxy)silane*, |
| Si(OCN)₄ | tetraisocyanatosilane, |
| CH₃Si(OCH₂CF₃)₃ | tris(2,2,2-trifluoroethoxy)methylsilane, |
| CH₃Si(OCOCF₃)₃ | tris(trifluoroacetoxy)methylsilane*, |
| CH₃Si(OCN)₃ | methyltriisocyanatosilane, |

[*These generate an acid catalyst upon exposure to water] and or combinations of any of the above.

In another embodiment of the invention, the composition includes a polymer synthesized from compounds denoted by Formula I by way of hydrolysis and condensation reactions, wherein the number average molecular weight ranges from about 150 to about 300,000 amu, or more typically from about 150 to about 10,000 amu.

In a further embodiment of the invention, silicon-containing prepolymers useful according to the invention include organosilanes, including, for example, alkoxysilanes according to Formula II:

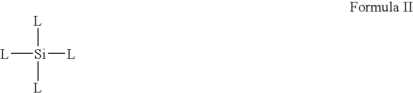

Optionally, Formula II is an alkoxysilane wherein at least 2 of the L groups are independently C₁ to C₄ alkoxy groups, and the balance, if any, are independently selected from the group consisting of hydrogen, alkyl, phenyl, halogen, substituted phenyl, substituted alkyl, substituted aryl. For purposes of this invention, the term alkoxy includes any other organic groups which can be readily cleaved from silicon at temperatures near room temperature by hydrolysis. L groups can be ethylene glycoxy or propylene glycoxy or the like, but preferably all four L groups are methoxy, ethoxy, propoxy or butoxy. The most preferred alkoxysilanes nonexclusively include tetraethoxysilane (TEOS) and tetramethoxysilane.

In a further option, for instance, the prepolymer can also be an alkylalkoxysilane as described by Formula II, but instead, at least 2 of the L groups are independently C₁ to C₄ alkylalkoxy groups wherein the alkyl moiety is C₁ to C₄ alkyl and the alkoxy moiety is C₁ to C₆ alkoxy, or ether-alkoxy groups; and the balance, if any, are independently selected from the group consisting of hydrogen, alkyl, phenyl, halogen, substituted phenyl. In one preferred embodiment each L is methoxy, ethoxy or propoxy. In another preferred embodiment at least two L groups are alkylalkoxy groups wherein the alkyl moiety is C₁ to C₄ alkyl and the alkoxy moiety is C₁ to C₆ alkoxy. In yet another preferred embodiment for a vapor phase precursor, at least two L groups are ether-alkoxy groups of the formula (C₁ to C₆ alkoxy)ₙ wherein n is 2 to 6.

In a further option, for instance, the prepolymer can also be an hydridoalkoxysilane as described by Formula II, but instead, at least 2 of the L groups are independently C₁ to C₄ alkylalkoxy groups and the balance is hydrogen. For this prepolymer, there is no Si—C bond in the structure.

Useful silicon-containing prepolymers include, for example, any or a combination of alkoxysilanes such as tetraethoxysilane, tetrapropoxysilane, tetraisopropoxysilane, tetra(methoxyethoxy)silane, tetra(methoxyethoxyethoxy)silane which have four groups which may be hydrolyzed and than condensed to produce silica, alkylalkoxysilanes such as methyltriethoxysilane silane, arylalkoxysilanes such as phenyltriethoxysilane and precursors such as triethoxysilane which yield SiH functionality to the film. Tetrakis(methoxyethoxyethoxy)silane, tetrakis(ethoxyethoxy)silane, tetrakis(butoxyethoxyethoxy)silane, tetrakis(2-ethylthoxy)silane, tetrakis(methoxyethoxy)silane, and tetrakis(methoxypropoxy)silane are particularly useful for the invention.

In a still further embodiment of the invention, the alkoxysilane compounds described above may be replaced, in whole or in part, by compounds with acetoxy and/or halogen-based leaving groups. For example, the prepolymer may be an acetoxy (CH₃—CO—O—) such as an acetoxysilane compound and/or a halogenated compound, e.g., a halogenated silane compound and/or combinations thereof. For the halogenated prepolymers the halogen is, e.g., Cl, Br, I and in certain aspects, will optionally include F. Preferred acetoxy-derived prepolymers include, e.g., tetraacetoxysilane, methyltriacetoxysilane and/or combinations thereof.

In one particular embodiment of the invention, the silicon containing prepolymer includes a monomer or polymer precursor, for example, acetoxysilane, an ethoxysilane, methoxysilane and/or combinations thereof.

In a more particular embodiment of the invention, the silicon containing prepolymer includes a tetraacetoxysilane, a C₁ to about C₆ alkyl or aryl-triacetoxysilane and combinations thereof. In particular, as exemplified below, the triacetoxysilane is a methyltriacetoxysilane.

In one embodiment of the invention the silicon containing prepolymer is present in the overall composition in an amount of from about 5 weight percent to about 90 weight percent. In another embodiment from about 10 weight percent to about 60 weight percent; and in yet another embodiment from about 15 weight percent to about 50 weight percent, based on the weight of the coating solution.

The dielectric precursor composition then contains a colloidal silica. Suitable colloidal silicas are described in U.S. Pat. No. 6,444,495, which is incorporated herein by reference. Methods for forming colloidal silica are known in the art as described, for example, in U.S. Pat. No. 3,634,558 and in Van Helden et al., (J. Colloid Interface Sci. 81, 354 (1981)), which are incorporated herein by reference. A familiar type of colloidal silica suspension comprises dispersions of small particles of silica in a liquid. According to one aspect of the present invention, a colloidal dispersion of nanometer scale silica particles, termed nanoparticles, dispersed in a solvent is used. In one embodiment the nanoparticles have a characteristic dimension of from about 2 nm to about 100 nm. In another embodiment the nanoparticles have a characteristic dimension of from about 2 nm to about 50 nm. The size distribution of the nanoparticles may be monodisperse, bimodal, or polydisperse. Bimodal distributions may be tailored to provide a higher packing density of nanoparticles, in which smaller particles fit into voids generated by packing of larger particles. The physical size of the nanoparticles should be substantially unchanged by thermal processing. The size of the nanoparticles should not be reduced by more than 10% when exposed to temperatures of about 700° C. Suitable silicon-containing materials for use as nanoparticles include silica, silicon, silicon nitride, silicon oxynitride, and combinations and mixtures thereof. For example, colloidal silica is advantageously used as the colloidal dispersion. In addition, colloidal silica is available commercially. Colloidal silica (SiO2) may be prepared form sodium silicate or from tetraalkoxysilane such as tetraethoxysilane.

The nanoparticles may be dispersed in an organic solvent or inorganic solvent, such as an aqueous solvent or solvent mixture, or in a supercritical fluid. Suitable organic solvents include solvents commonly used in coating solutions of spin-on polymers, such as methanol, ethanol, isopropyl alcohol, methylisobutylketone, cyclohexanone, propylene glycol monomethyl ether (PGME), propylene glycol monomethyl ether acetate (PGMEA), acetone, and anisole, among others. The solid content of nanoparticles in the colloidal dispersion typically ranges from about 0.5 weight % to about 35%. Higher or lower concentrations may be used to adjust the coating thickness. Additional additives such as surfactants, stabilizing agents such as counter ion, or binders may also be present in the dispersion. A surface modified colloidal silica may also be used.

In one embodiment of the invention the colloidal silica is present in the overall composition in an amount of from about 10 weight percent to about 95 weight percent. In another embodiment from about 30 weight percent to about 90 weight percent; and in yet another embodiment from about 50 weight percent to about 85 weight percent based on the solid parts of the composition.

For non-microelectronic applications, the onium or nucleophile catalyst may contain metal ions. Examples include sodium hydroxide, sodium sulfate, potassium hydroxide, lithium hydroxide, and zirconium containing catalysts.

For microelectronic applications, the composition then optionally, but preferably contains a metal-ion-free catalyst which may be, for example an onium compound or a nucleophile. For purposes of this invention, metal ion free means substantially free of metal ions, although not necessarily completely free on metal ions, the catalyst may be, for example an ammonium compound, an amine, a phosphonium compound or a phosphine compound. Non-exclusive examples of such include tetraorganoammonium compounds and tetraorganophosphonium compounds including tetramethylammonium acetate, tetramethylammonium hydroxide, tetrabutylammonium acetate, triphenylamine, trioctylamine, tridodecylamine, triethanolamine, tetramethylphosphonium acetate, tetramethylphosphonium hydroxide, triphenylphosphine, trimethylphosphine, trioctylphosphine, and combinations thereof.

The composition may comprise a non-metallic, nucleophilic additive which accelerates the crosslinking of the composition. These include dimethyl sulfone, dimethyl formamide, hexamethylphosphorous triamide (HMPT), amines and combinations thereof. The catalyst is usually present in the overall composition in an amount of from about 1 ppm by weight to about 1000 ppm, more usually from about 2 ppm by weight to about 500 ppm, and still more usually present in the overall composition in an amount of from about 6 ppm to about 200 ppm.

The overall composition then optionally includes a solvent or solvent composition. Reference herein to a “solvent” should be understood to encompass a single solvent, polar or nonpolar and/or a combination of compatible solvents forming a solvent system selected to solubilize the overall composition components. A solvent is optionally included in the composition to lower its viscosity and promote uniform coating onto a substrate by art-standard methods.

In order to facilitate solvent removal, the solvent is one which has a relatively low boiling point relative to the boiling point of the precursor components. For example, solvents that are useful for the processes of the invention have a boiling point ranging from about 50° C. to about 250° C. to allow the solvent to evaporate from the applied film and leave the active portion of the precursor composition in place. In order to meet various safety and environmental requirements, the solvent preferably has a high flash point (generally greater than 40° C.) and relatively low levels of toxicity. A suitable solvent includes, for example, hydrocarbons, as well as solvents having the functional groups C—O—C (ethers), —CO—O (esters), —CO— (ketones), —OH (alcohols), and —CO—N-(amides), and solvents which contain a plurality of these functional groups, and combinations thereof. Suitable solvents for use in such solutions of the present compositions include any suitable single or mixture of organic, organometallic, or inorganic molecules that are volatized at a desired temperature. Suitable solvents non-exclusively include aprotic solvents, for example, cyclic ketones such as cyclopentanone, cyclohexanone, cycloheptanone, and cyclooctanone; cyclic amides such as N-alkylpyrrolidinone wherein the alkyl has from about 1 to 4 carbon atoms; and N-cyclohexylpyrrolidinone and mixtures thereof. A wide variety of other organic solvents may be used herein insofar as they are able to aid dissolution of the adhesion promoter and at the same time effectively control the viscosity of the resulting solution as a coating solution. Various facilitating measures such as stirring and/or heating may be used to aid in the dissolution. Other suitable solvents include methyethylketone, methylisobutylketone, dibutyl ether, cyclic dimethylpolysiloxanes, butyrolactone, γ-butyrolactone, 2-heptanone, ethyl 3-ethoxypropionate, 1-methyl-2-pyrrolidinone, and propylene glycol methyl ether acetate (PGMEA), and hydrocarbon solvents such as mesitylene, xylenes, benzene, toluene di-n-butyl ether, anisole, acetone, 3-pentanone, 2-heptanone, ethyl acetate, n-propyl acetate, n-butyl acetate, ethyl lactate, ethanol, 2-propanol, dimethyl acetamide, propylene glycol methyl ether acetate, and/or combinations thereof. It is better that the solvent does not react with the silicon containing prepolymer component.

The solvent component may be present in an amount of from about 10% to about 95% by weight of the overall composition. A more usual range is from about 20% to about 75% and most usually from about 20% to about 60%. The greater the percentage of solvent employed, the thinner is the resulting film.

In another embodiment of the invention the composition may comprise water, either liquid water or water vapor. For example, the overall composition may be applied to a substrate and then exposed to an ambient atmosphere that includes water vapor at standard temperatures and standard atmospheric pressure. Optionally, the composition is prepared prior to application to a substrate to include water in a proportion suitable for initiating aging of the precursor composition, without being present in a proportion that results in the precursor composition aging or gelling before it can be applied to a desired substrate. By way of example, when water is mixed into the precursor composition it is present in a proportion wherein the composition comprises water in a molar ratio of water to Si atoms in the silicon containing prepolymer ranging from about 0.1:1 to about 50:1. In another embodiment, it ranges from about 0.1:1 to about 10:1 and in still another embodiment from about 0.5:1 to about 1.5:1.

The overall composition may also comprise additional components such as adhesion promoters, antifoam agents, detergents, flame retardants, pigments, plasticizers, stabilizers, and surfactants. Surfactants may be ionic, non-ionic, anionic or amphoteric. Suitable surfactants non-exclusively include BYK306 and BYK 307 (silicone surface active agents sold by BYK-Cera, 1 AM Deventer, Holland). The composition also has utility in non-microelectronic applications such as thermal insulation, encapsulant, matrix materials for polymer and ceramic composites, light weight composites, acoustic insulation, anti-corrosive coatings, binders for ceramic powders, and fire retardant coatings. In another embodiment of the invention, the composition further comprises phosphorous and/or boron doping. Typically, the optional phosphorous and/or boron is present in an amount ranging from 10 parts per million to 10% by weight of the composition.

Those skilled in the art will appreciate that specific conditions for crosslinking from the dielectric films will depend on the selected materials, substrate and desired structure, as is readily determined by routine manipulation of these parameters. Generally, the coated substrate is subjected to a treatment such as heating, UV or e-beam to effect crosslinking of the composition on the substrate to produce a substantially crack-free, silicon-based dielectric film. In some applications, film comprising no SiC bond is preferred. In other applications, the film may have various SiC:SiO bond ratios.

The film preferably has a transparency to light in the range of about 400 nm to about 800 nm of about 90% or more, preferably about 95% or more, and usually about 99% or more. In one embodiment the silica dielectric film has a transparency to light in the range of about 400 nm to about 800 nm of about 100%. In one embodiment, crossinkling this may be done by heating at a temperature of about 600° C. or less. In another embodiment, the crosslinking is conducted by heating the composition at a temperature of about 400° C. or less. In another embodiment, heating is conducted at a temperature of from about 200° C. or less. In another embodiment the crosslinking is conducted by heating the composition at a temperature of from about 125° C. to about 500° C. In another embodiment the crosslinking is conducted by heating the composition at a temperature of from about 125° C. to about 250° C. In another embodiment the crosslinking is conducted by heating the composition at a temperature of from about 150° C. to about 425° C. In another embodiment the crosslinking is conducted by heating the composition at a temperature of from about 225° C. to about 250° C. In another embodiment useful temperatures range from about 150° C. to about 250° C., in another embodiment the useful temperatures range from about 160° C. to about 240° C., and in still another embodiment, the useful temperatures range from about 180° C. to about 200° C.

In one embodiment the crossinkling this may be done by heating for about 120 minutes or less. In another embodiment, the heating may be conducted for about 90 minutes or less. In another embodiment, the heating may be conducted for about 60 minutes or less. In another embodiment, the heating may be conducted for about 30 minutes or less. In another embodiment, the heating may be conducted for from about 1 minute to about 30 minutes. In another embodiment it may be for a time period ranging from about 5 minutes to about 20 minutes and in still another embodiment from about 10 minutes to about 15 minutes.

In another embodiment of the invention, the film may be subjected to a curing treatment. Such may be done by the application of heat, ultraviolet radiation, or combinations of heating and ultraviolet radiation. The use of ultraviolet radiation lowers the temperature and total amount of heat applied to achieve a cured film. A heat curing may be done by baking at about 250° C. or less, preferably from 125° C. to about 500° C. for from about 10 minutes to about 120 minutes, preferably about 10 minutes to about 60 minutes. An ultraviolet curing may be done by exposure to a broad or narrow spectrum of wavelengths in the range of about 100 nm to about 400 nm, preferably from about 172 nm to about 250 nm. A typical ultraviolet radiation exposure dose is from about 100 mJ/cm² to about 200 mJ/cm². When a combination of heating and ultraviolet radiation are used for curing, the temperature may typically be from about 125° C. to about 500° C., preferably about 250° C. or less, and usually from about 125° C. to about 250° C. Preferably the resulting silica film is low porosity, crack free, and has essentially no organic or carbon containing groups. Preferably the film has a thickness of from about 100 Å to about 20 micrometers, preferably from about 7000 Å to about 2 micrometers, and more preferably from about 5000 Å to about 2 micrometers.

Films can be further heated to anneal at temperature greater than 1000° C. to increase mechanical strength and electrical breakdown voltage. High temperature annealing is applicable to film which contains no SiC with coating on ceramic or metal substrates.

The composition may be used in electrical devices and more specifically, as an interlayer dielectric in an interconnect associated with a single integrated circuit (“IC”) chip. An integrated circuit chip typically has on its surface a plurality of layers of the present composition and multiple layers of metal conductors. It may also include regions of the present composition between discrete metal conductors or regions of conductor in the same layer or level of an integrated circuit. The films are preferably substantially planarized, i.e., globally, regionally and/or locally planarized. Planarizing smoothes or levels the topography of microelectronic device layers in order to properly pattern the increasingly complex integrated circuits. As used herein, the term “local planarization” refers to a condition wherein the film is planar or flat over a distance of 0 to about 5 linear micrometers. “Regional planarization” refers to a condition wherein the film is planar or flat over a distance of about 5 to about 50 linear micrometers. “Global planarization” refers to a condition wherein the film is planar or flat over a distance of about 50 to about 1000 linear micrometers. Planarization may be achieved according to U.S. Pat. No. 6,407,006, which is incorporated herein by reference.

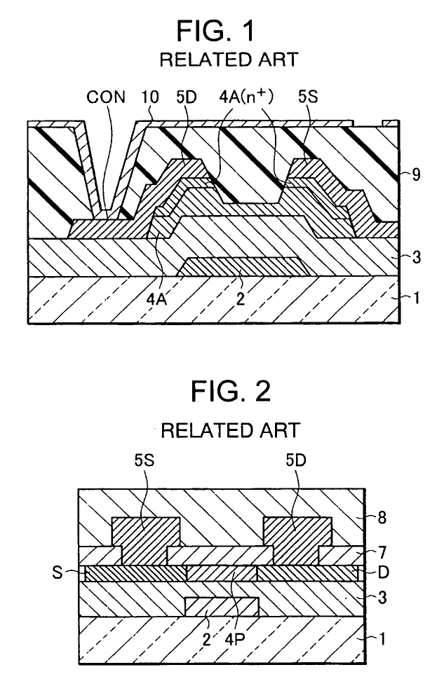

FIGS. 1 and 2 show a known method of forming a flat panel display. As shown in FIG. 1, a metal gate electrode 2 is formed on a base plate (substrate) 1 made of glass or the like. A gate insulation film 3 is formed so as to cover the gate electrode 2. On the gate insulation film 3, a semiconductor thin film 4A is formed, which operates as an active layer of a thin film transistor. On one end side of the semiconductor thin film 4A, a drain electrode 5D is formed with a semiconductor thin film 4A(n+), which has a high impurity concentration and is made to have low resistance, inserted between the drain electrode 5D and the semiconductor thin film 4A. On the other end side of the amorphous (non-crystalline) semiconductor thin film 4A, a source electrode 5S is formed with another amorphous semiconductor thin film 4A(n+), which is also made to have low resistance, inserted between the source electrode 5S and the amorphous semiconductor thin film 4A. A leveling film 9 is formed so as to cover the drain electrode 5D and the source electrode 5S. On the leveling film 9, a pixel electrode 10, which comprises a transparent conductive film such as a film including indium tin oxide as its main ingredient is formed to connect electrically with the drain electrode 5D through a contact hole CON.

As shown in FIG. 2, a gate electrode 2 is formed on a glass base plate 1. A gate insulation film 3 is formed so as to cover the gate electrode 2. A polycrystalline semiconductor thin film 4P is formed above the gate electrode 2 with a gate insulation film 3 inserted between the polycrystalline semiconductor thin film 4P and the gate electrode 2. A part of the polycrystalline semiconductor thin film 4P placed right above the gate electrode 2 is formed as a channel region, and parts on both sides of the channel region are formed as a source region S and a drain region D locations, where impurities are injected in a high concentration. The semiconductor thin film 4P is covered with an interlayer insulation film 7 and spaces where insulation film 7 has been previously patterned and etched away, and a drain electrode 5D and a source electrode 5S are formed on the interlayer insulation film 7. These electrodes 5D and 5S are covered with a protection film 8. The film of the present invention may be used, for example, as the gate insulation film 3, interlayer insulation film 7, protection film 8 or leveling film 9 in these structures.

The following non-limiting examples serve to illustrate the invention.

### EXAMPLE 1

### Silicate Resin Film (Control)

Synthesis Procedure

Mix 83.0 gm acetone, 83.0 gm isopropyl alcohol, 257 gm propylene glycol monomethyl ether acetate (PGMEA) and 600 gm tetraethoxysilane (TEOS) in a plastic bottle. Mix 94.4 gm 0.1N nitric acid and 83 gm D.I. water. Add the nitric acid/water mix to the first solution at a rate of less than 3 ml per minute. Stir at room temperature for 24 hours. Store the resultant solution in a refrigerator at 2° C. to 5° C. This solution is called “T30 (6KA)”.

Crack Threshold

T30(6KA) was used to coat a film on 4″ Si wafers using an SVG coater. The spin speed is listed in the first column of Table 1. The spin time was 60 seconds. The first bake was at 125° C. for 1 minute and the second bake was at 250° C. for 1 minute. After baking, the film thickness and refractive index were measured. The coated wafers were then cured in air for 60 minutes. Post cure film thickness and refractive index were measured. Films were examined for cracks.

TABLE 1
T-30 4″ experiment (6K formulation)

| Spin | Post Bake | | | Post Cure | | | Shrink- |
|---|---|---|---|---|---|---|---|
| rpm | thickness | RI | MSE | thickness | RI | MSE | age |
| 800 | 8935 | 1.4463 | 2.4 | Post cure Cracked | | | |
| 1000 | 8441 | 1.448 | 2.3 | Post cure Cracked | | | |
| 1100 | 8133 | 1.4488 | 2.5 | 7276 | 1.4324 | 2.9 | 10.5% |
| 1200 | 7848 | 1.4484 | 2.6 | 7024 | 1.4318 | 2.3 | 10.5% |
| 1300 | 7550 | 1.4498 | 2.8 | 6776 | 1.4315 | 2.4 | 10.2% |
| 1400 | 7121 | 1.4485 | 2.7 | 6403 | 1.4318 | 1.9 | 10.1% |

It can be seen that the post cure films crack for thickness greater than about 7300 Å.

### EXAMPLE 2

### Colloidal Silica Filled T30 Films

The colloidal silica used is a stable suspension of 11 nm diameter particles, comprising 20 wt % colloidal silica and 80 wt % cyclohexanone.

Appropriate amounts of 20% colloidal silica (CS) solution were mixed with 12.00 gm of T30(6KA) according to the ratio listed in column one of Table 2. For example, for a ratio of 0.375, 4.5 gm of 20% colloidal silica was mixed with 12.00 gm T30(6KA). In addition, 0.2 to 0.45 wt % of 1% tetramethylammonium acetate (TMAA) was added to the spin-on solution. The solution, after mixing, was left standing at room temperature for 2 to 5 hours. The solution was then filtered through a 1μ Teflon syringe filter.

Spin coating was performed using an SVG spin coater on 4″ Si wafers. Spin speed was listed in the last column of Table 2 with a spin time of 60 seconds. First baking was at 125° C. for 1 minute and the second baking was at 250° C. for 1 minute. After baking, the film thickness and refractive index were measured. The coated wafers were then cured in air for 60 minutes. Post cure film thickness and refractive index were measured. Films were examined for cracking.

TABLE 2

| | Wt. of | | | | | | Shrinkage % | |
|---|---|---|---|---|---|---|---|---|
| | 20% CS/ | Post | Post Bake | Post | Post Cure | | (250° C. | Spin |
| Sample | wt of | Bake | Thickness, | Cure | Thickness, | | to | Speed |
| No. | T30 | R.I. | Angstroms | R.I. | Angstroms | | 400° C.) | rpm |
| 2A | 0.375 | 1.434 | 8363 | 1.434 | 8050 | cracks | 9.3 | 900 |
| 2B | 0.625 | 1.439 | 8505 | 1.427 | 8237 | cracks | 3.2 | 900 |
| 2C | 0.75 | 1.425 | 8368 | 1.428 | 8096 | cracks | 3.2 | 1000 |
| 2D | 1.67 | 1.369 | 9865 | 1.369 | 9540 | no cracks | 4 | 800 |
| 2E | 2.92 | 1.34 | 9403 | 1.346 | 9238 | no cracks | 1.8 | 1100 |
| 2F | 5 | 1.309 | 10152 | 1.291 | 10212 | no cracks | 0 | |

Refractive index decreases with increasing colloidal silica loading, yielding a porous silica structure. Cracking threshold is greater than 10K Å for Sample 2F.

The Example 2, Sample 2F and Example 1T30 films were coated onto high resistivity Si wafers. FTIR of the post cure films, indicates silicate structures with no carbon components.

### EXAMPLE 3

### Film Characterization

(A) Sample A

42.00 gm of 20% colloidal silica in cyclohexanone was mixed with 8.40 gm T30(6KA), corresponding to ratio of 5 as in sample 2F of Table 2. 0.21 gm 1% tetramethylammonium acetate in acetic acid was added. The solution was left at room temperature for 18 hours. Solution was then filtered through 5 μm Nylon filter

(B) Sample B

31.25 gm of 20% colloidal silica in cyclohexanone was mixed with 18.75 gm T30(6KA), corresponding to a ratio of 1.66 as in sample 2D of Table 2. 0.21 gm 1% tetramethylammonium acetate in acetic acid was added. The solution was left at room temperature for 18 hours. Solution was then filtered through 5 μm Nylon filter.

Both solutions were coated onto 8″ wafer and glass substrate. Data are shown in Table 3. For Sample A, with a ratio of 5.00, cured to a crack-free film and a thickness of 1.4 um was obtained. This demonstrates the crack threshold can be at least double over the control T30 with the addition of colloidal silica. The refractive index of this film was 1.307, indicating a porous structure. With double coats, a crack-free 1.45 μm film was obtained.

TABLE 3

| | | Wt ratio | | | | | | |
|---|---|---|---|---|---|---|---|---|
| | | of CS | | | | | | |
| | Spin | solution | Post Bake | | Post Cure | | % | |
| Lot # | rpm | to T30 | Thickness | RI | Thickness | RI | Shrinkage | Film Quality |
| 40445- | 800 | 1.66 | 7897 | 1.404 | 7768 | 1.398 | −1.6 | Striations, NO |
| 36 B | | | | | | | | Cracks |
| 40445- | 700 | 1.66 | 8566 | 1.408 | 8441 | 1.403 | −1.5 | Striations, NO |
| 36 B | | | | | | | | Cracks |
| 40445- | 800 | 5.00 | 9253 | 1.297 | 9130 | 1.294 | −1.3 | Good, NO |
| 36 A | | | | | | | | Cracks |
| 40445- | 1900 | 5.00 | 12073 | 1.305 | 11949 | 1.301 | −1.0 | Good, NO |
| 36 A | double | | | | | | | Cracks |
| | coat | | | | | | | |
| 40445- | 1500 | 5.00 | 13472 | 1.308 | 13261 | 1.306 | −1.6 | Good, NO |
| 36 A | double | | | | | | | Cracks |
| | coat | | | | | | | |
| 40445- | 1300 | 5.00 | 14445 | 1.310 | 14279 | 1.306 | −1.1 | Good, NO |
| 36 A | double | | | | | | | Cracks |
| | coat | | | | | | | |

Film thickness on glass substrate is listed in Table 4.

TABLE 4

| | | Wt Ratio | | |
|---|---|---|---|---|
| | | of CS | Post Cure | |
| | Spin | solution to | Thickness | |
| Lot # | rpm | T30 | (HRP) | Comment |
| 40445-36 B | 800 | 1.66 | 7476 | Particles, No cracks |
| 40445-36 A | 800 | 5.00 | 9307 | Particles, No Cracks |

TABLE 5
Wet etch rate in 40:1 DHF

| | |
|---|---|
| % | 40:1 |
| Colloidal | DHF (10 sec) |

| Silica | Material | pre | post | ER (A/min) |
|---|---|---|---|---|
| 0 | T-30 | 6507 | 6214 | 1758 |
| | POR | | | |
| 1.66 | T30 + | 8498 | 5103 | 20370 |
| | 1.66 | | | |
| | Colloidal | | | |
| | Silica | | | |
| 5.00 | T30 + | 12085 | 1942 | 60858 |
| | 5.0 | | | |
| | Colloidal | | | |
| | Silica | | | |

TABLE 6
Wet Etch Rate in 500:1 DHF

| | |
|---|---|
| % | 500:1 DHF |
| Colloidal | (3 min) |

| Silica | Material | pre | post | ER (A/min) |
|---|---|---|---|---|
| 0 | T-30 | 6481 | 6241 | 80 |
| | POR | | | |
| 1.66 | T30 + | 8524 | 8713 | −63 |
| | 1.66 | | | |
| | Colloidal | | | |
| | Silica | | | |
| 5.00 | T30 + | 11927 | 10096 | 610 |
| | 5.0 | | | |
| | Colloidal | | | |
| | Silica | | | |

TABLE 7
Modulus & Hardness

| | | Modulus | % | Hardness | |
|---|---|---|---|---|---|
| Material | lot # | (Gpa) | stdev | (Gpa) | % stdev |
| T30 | POR | 34.5 | 3.7 | 3.2 | 3.2 |
| T30 + 1.66CS | 40445- | 24.3 | 3.7 | 1.9 | 4.4 |
| | 36B | | | | |
| T30 + 5.00CS | 40445- | 11.5 | 4.0 | 0.8 | 4.5 |
| | 36A | | | | |

### EXAMPLE 4

Colloidal silica used is a stable suspension of 16 nm diameter particle, comprising 30 wt % colloidal silica and 70 wt % propylene glycol monomethyl ether acetate (PGMEA).

Appropriate amounts of 30% colloidal silica (CS) solution were mixed with T30(6KA) according to the ratio listed in column one of Table 8. For example, for Sample 4E with a ratio of 3.25, 58.5 gm of 30% colloidal silica was mixed with 18.00 gm T30(6KA). The solution after mixing was left standing at room temperature for 2 to 5 hours. The solution was then filtered through 0.2u Teflon syringe filter.

Spin coating was performed using a SVG spin coater on 4″ Si wafer. Spin speed was listed in the last column of Table 8 with spin time of 60 seconds. First baking was 125° C. for 1 minute and the second baking was at 250° C. for 1 minute. After baking, film thickness and refractive index were measured. The coated wafer was then cured in air for 60 minutes. Post cure film thickness and refractive index were measured. Films were examined for cracks.

TABLE 8

| | Wt. | Post | Post | Post | Post | | |
|---|---|---|---|---|---|---|---|
| | ratio of | Bake | Bake | Cure | Cure | | |
| | CS | Thick- | Refrac- | Thick- | Refrac- | Post | |
| Sample | solution | ness, | tive | ness, | tive | Cure | Spin |
| No. | to T30 | A | Index | A | Index | Film | Speed |
| 4A | 1.125 | 11091 | 1.412 | 10589 | 1.426 | crack | 1200 |
| | | | | | | | rpm |
| 4B | 1.286 | 11185 | 1.413 | na | na | na | 1200 |
| | | | | | | | rpm |
| 4C | 1.708 | 11770 | 1.402 | 11326 | 1.397 | crack | 1200 |
| | | | | | | | rpm |
| 4D | 2.333 | 12256 | 1.387 | 11875 | 1.382 | no | 1200 |
| | | | | | | | rpm |
| 4E | 3.25 | 12689 | 1.356 | 12162 | 1.377 | no | 1200 |
| | | | | | | | rpm |
| 4F | 3.25 | 12854 | 1.361 | 12435 | 1.364 | no | 1200 |
| | | | | | | | rpm |
| 4G | 8.333 | 13278 | 1.326 | na | na | na | 1200 |
| | | | | | | | rpm |

It can be seen that crack threshold increases substantially to greater than 1.1 um for film with refractive index below about 1.39.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A dielectric precursor composition comprising a substantially uniform admixture of a silicon containing pre-polymer and a colloidal silica.

2. The dielectric precursor of claim 1 further comprising water, a solvent for the silicon containing pre-polymer, a polymerization catalyst, or combinations thereof.

3. A dielectric composition comprising a substantially uniform admixture of a silicon-based dielectric polymer and a colloidal silica.

4. A dielectric film comprising the dielectric composition of claim 3, which film has a transparency to light in the range of about 400 nm to about 800 nm of about 90% or more.

5. The dielectric film of claim 4 which is substantially crack-free and has a thickness of from about 100 Å to about 20 micrometers.

6. The dielectric film of claim 4 which is substantially crack-free and has a thickness of from about 5000 Å to about 2 micrometers.

7. A device which comprises a substrate and the dielectric film of claim 4 on the substrate, which substrate has a transparency to light in the range of about 400 nm to about 800 nm of about 90% or more.

8. The device of claim 7 wherein the substrate comprises a film, glass, ceramic, plastic, metal, composite material, silicon composition, and semiconductor materials and combinations thereof.

9. The device of claim 7 wherein the substrate comprises electrodes.

10. The device of claim 7 which is a flat panel display.

11. A method of producing a dielectric film comprising:
(a) preparing a dielectric precursor composition comprising a substantially uniform admixture of a silicon containing pre-polymer and a colloidal silica;
(b) coating a substrate with the dielectric precursor composition to form a film on the substrate;
(c) crosslinking the dielectric precursor composition to produce a dielectric film comprising a substantially uniform admixture of a silicon containing dielectric polymer and a colloidal silica, such film having a transparency to light in the range of about 400 nm to about 800 nm of about 90% or more.

12. The method of claim 11 wherein the dielectric precursor further comprises water, a solvent for the silicon containing pre-polymer, a polymerization catalyst, a surfactant, or combinations thereof.

13. The method of claim 12 wherein the dielectric film comprises dielectric polymer in an amount of from about 5 to about 90% based on the weight of the dielectric film, and from about 10% to about 95% colloidal silica based on the weight of the dielectric film.

14. The method of claim 11 wherein the colloidal silica has a particle size of from about 1 nm to about 1000 nm.

15. The method of claim 11 wherein the dielectric film is substantially crack free.

16. The method of claim 11 wherein the dielectric film has a thickness of from about 100 Å to about 2 micrometers.

17. The method of claim 11 wherein the dielectric film is substantially planarized on the substrate.

18. The method of claim 11 wherein step (c) is conducted by heating the composition at a temperature of about 1000° C. or less.

19. The method of claim 11 wherein step (c) is conducted by heating the composition at a temperature of about 600° C. or less.

20. The method of claim 11 wherein step (c) is conducted by heating for about 120 minutes or less.

21. The method of claim 12 wherein the catalyst comprises a catalyst selected from the group consisting of onium compounds, alkali metals and nucleophiles.

22. The method of claim 12 wherein the catalyst is selected from the group consisting of tetramethylammonium acetate, tetramethylammonium hydroxide, tetrabutylammonium acetate, triphenylamine, trioctylamine, tridodecylamine, triethanolamine, tetramethylphosphonium acetate, tetramethylphosphonium hydroxide, triphenylphosphine, trimethylphosphine, trioctylphosphine, and combinations thereof.

23. The method of claim 11 wherein the silicon containing pre-polymer a pre-polymer of Formula I:
Rx-Si-Ly (Formula I)
wherein x is an integer ranging from 0 to about 2, and y is 4-x, an integer ranging from about 2 to about 4;
R is independently selected from the group consisting of alkyl, aryl, hydrogen, alkylene, arylene, substituted alkyl, substituted aryl, and combinations thereof;
L is an electronegative moiety, independently selected from the group consisting of alkoxy, carboxyl, acetoxy, amino, amido, halide, isocyanato and combinations thereof.

24. The method of claim 11 wherein the silicon containing pre-polymer comprises a pre-polymer of Formula II: 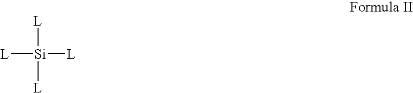
wherein at least 2 of the L groups are independently C₁ to C₄ alkoxy groups, and the balance, if any, are independently selected from the group consisting of hydrogen, alkyl, phenyl, halogen, substituted phenyl, substituted alkyl, substituted aryl.

25. The method of claim 23 wherein the L groups are independently C₁ to C₄ alkoxy groups.

26. The method of claim 23 wherein the silicon containing pre-polymer comprises triethoxysilane.

27. The method of claim 23 wherein the silicon containing pre-polymer comprises tetraethoxysilane.

28. The method of claim 11 wherein the dielectric precursor composition comprises a solvent selected from the group consisting of hydrocarbons, esters, ethers, ketones, alcohols, amides and combinations thereof.

29. The method of claim 11 further comprising the subsequent step of curing the film.

30. The method of claim 11 further comprising the subsequent step of curing the film by subjecting the film to an ultraviolet radiation exposure treatment, a heating treatment or combinations of an ultraviolet radiation exposure treatment and a heating treatment.

31. A display which comprises a substrate having a surface, which substrate has a transparency to light in the range of about 400 nm to about 800 nm of about 90% or more; a plurality of electrodes on the surface, and the dielectric film of claim 4 on the substrate and the electrodes.
